(19) United States
(12) Patent Application Publication
(10) Pub. No.: US 2026/0365087 A1
(43) Pub. Date: Nov. 19, 2026

(54) WALK-IN ADJUSTMENT DEVICES AND VEHICLE SEAT HAVING THE SAME

(71) Applicant: DAS CO., LTD, Gyeongju-si (KR)

(72) Inventors: Dong Gun LEE, Yongin- si (KR); Jang Woo BYUN, Yongin-si (KR); Kyung Soo OH, Yongin-si (KR); Song Min BAEK, Yongin-si (KR)

(21) Appl. No.: 19/422,942

(22) Filed: Dec. 17, 2025

(30) Foreign Application Priority Data
May 15, 2025 (KR) 10-2025-0062954

(51) Int. Cl. B60N 2/12

(52) U.S. Cl. CPC B60N 2/12

(57) ABSTRACT

The present invention provides a walk-in adjustment device for a vehicle seat, which includes a movable rail movably installed on a fixed rail, a front plate hinge-coupled to a front surface of the movable rail, a rear plate hinge-coupled to the front plate, a rear link whose one side is rotatably installed on the rear plate and the other side hinge-coupled to a rear surface of the movable rail, a rail lock which selectively fixes the position of the movable rail and is installed to be exposed to the movable rail, a track lever rotatably coupled to the movable rail so that one end portion selectively comes into contact with the rail lock, and a release bracket which is coupled to the front plate so that the rail lock is linked according to the rotation of the rear link and comes into contact with the track lever.

### CROSS REFERENCE TO RELATED APPLICATION

The present application claims priority to Korean Patent Application No. 10-2025-0062954, filed May 15, 2025, the entire contents of which is incorporated herein for all purposes by this reference.

### BACKGROUND OF THE INVENTION

### Field of the Invention

The present invention relates to an adjustment device for a vehicle seat, and more specifically, to a tilting-type walk-in adjustment device for a vehicle seat and a vehicle seat having the same.

### Description of the Related Art

Typically, various convenience devices are provided in seats, such as a driver's seat, a front passenger's seat, and a rear passenger's seat, which are installed in the front and rear interior areas of a vehicle to enhance passenger comfort.

The seats for a vehicle are configured to use a space inside the vehicle by maximally bringing a seatback into close contact with a seat cushion. For example, the vehicle seats have a sliding function, which allows the seat to be moved forward and rearward to be adjusted according to the passenger's body type, and a reclining function, which adjusts the inclination of a backrest of the seat (seatback). The sliding function is also referred to as a walk-in function, and the reclining function is also referred to as a folding function.

The folding function is implemented via a recliner, allowing an angle of the seatback to be adjusted with respect to the seat cushion.

The walk-in function is implemented via a walk-in module mounted on the seat, and the walk-in module can operate in conjunction with a recliner or independently by operating a lever.

The walk-in function is mainly used in SUV or van-type vehicles in which the seats are arranged in three rows in order to secure an access passage for passengers inside the vehicle. That is, the walk-in function allows the second-row seat to be moved forward and rearward to facilitate passenger entry to and exit from the third-row seat.

Meanwhile, the walk-in function typically allows the entire seat to be moved forward and rearward in a state in which the seatback is folded with respect to the seat cushion.

However, the walk-in function has a limitation in securing an access passage area.

To this end, the applicant has proposed a technology of Korean Patent Laid-Open Publication No. 10-2024-0076912 (published on May 31, 2024) to secure a wider access passage area.

The proposed technology is a tilting-type walk-in adjustment device for a vehicle seat, and during walk-in operation, the seatback of the vehicle is rotated forward to raise the seat and at the same time, the seat cushion is tilted.

### DOCUMENTS OF RELATED ART

### Patent Documents

(Patent Document 1) Korean Patent Laid-Open Publication No. 10-2024-0076912 (published on May 31, 2024)

### SUMMARY OF THE INVENTION

The present invention relates to a tilting-type walk-in adjustment device and is directed to providing a further improved walk-in adjustment device for a vehicle seat and a vehicle seat including the same, which can perform a walk-in operation quickly and accurately with a simplified mechanism while reducing the number of components.

The present invention provides a walk-in adjustment device for a vehicle seat, which includes a movable rail movably installed on a fixed rail, a front plate hinge-coupled to a front surface of the movable rail, a rear plate hinge-coupled to the front plate, a rear link whose one side is rotatably installed on the rear plate and the other side hinge-coupled to a rear surface of the movable rail, a rail lock which selectively fixes the position of the movable rail and is installed to be exposed to the movable rail, a track lever rotatably coupled to the movable rail so that one end portion selectively comes into contact with the rail lock, and a release bracket which is coupled to the front plate so that the rail lock is linked according to the rotation of the rear link and comes into contact with the track lever.

The release bracket may release the fixation of the movable rail by coming into contact with the track lever as the front plate rotates vertically.

The release bracket may include a fixed piece fixed to the front plate, an extension piece extending from the fixed piece, and a support piece which is connected to the extension piece and supports the track lever.

The fixed piece may be fixed to the front plate by welding.

The track lever may include an end cover which surrounds an end portion of the track lever and comes into contact with the rail lock, a lever rotational shaft which rotatably couples the end cover to the movable rail, and a lever stopper which limits a range of the rotation of the end cover.

The lever stopper may include a long hole formed through the movable rail, and a long shaft coupled to the end cover and inserted into the long hole.

The rail lock may include a lock bracket which selectively comes into contact with the end cover to lock and unlock the movable rail and the fixed rail, and a lock spring which elastically supports the lock bracket.

The rear link may include a sector gear unit rotatably installed on the rear plate, a horizontal link rotatably installed on the rear plate, and a vertical link extending from the horizontal link and having the sector gear unit provided at an end portion thereof.

The walk-in adjustment device may further include a rocker arm rotatably installed on the rear plate so that one end engages with the sector gear unit of the rear link and the other end selectively engages with the release bracket.

Meanwhile, the present invention provides a vehicle seat including any one of the walk-in adjustment devices for a vehicle seat.

### BRIEF DESCRIPTION OF THE DRAWINGS

FIG. 1 is an exploded perspective view of main parts of a vehicle seat provided with a walk-in adjustment device according to one embodiment of the present invention.

FIG. 2 is an enlarged view of a seatback frame area provided with a stand-up lever of FIG. 1.

FIG. 3 is a perspective view of the walk-in adjustment device of FIG. 1 when viewed in an opposite direction.

FIG. 4 is an enlarged view illustrating main parts of FIG. 3.

FIG. 5 is a side view of a vehicle seat provided with the walk-in adjustment device according to one embodiment of the present invention before walk-in operation.

FIG. 6 illustrates a state in which a walk-in mode of FIG. 5 is in progress, in which the seat partially moves forward, a seatback remains upright, and a seat cushion rotates and stands up.

FIG. 7 is an enlarged view illustrating main parts of FIG. 6.

FIG. 8 illustrates a completed state of the walk-in mode of FIG. 6, in which the seat has moved forward and the seatback and the seat cushion have been completely erected.

FIG. 9 is an enlarged view illustrating main parts of FIG. 8.

FIG. 10 is an enlarged view illustrating main parts of FIG. 1.

FIG. 11 is a front view of FIG. 10.

FIG. 12 illustrates a state before the seat stands up, in which a release bracket does not come into contact with a track lever.

FIG. 13 illustrates the seat during the stand-up operation, in which the release bracket comes into contact with the track lever and an end cover presses a rail lock.

FIG. 14 illustrates a state after the seat stands up, in which the release bracket comes into contact with the track lever and the end cover maximally presses a rail lock.

### DETAILED DESCRIPTION OF THE INVENTION

Hereinafter, exemplary embodiments of the present invention will be described in detail with reference to the accompanying drawings.

Since the present invention may have various changes and various embodiments, specific embodiments are illustrated in the accompanying drawings and specifically described in the detailed descriptions. This is not intended to limit the present invention to specific embodiments and should be construed to include all modifications, equivalents, and substitutes included in the spirit and technical scope of the present invention.

In the description of the present invention, terms such as first and second may be used to describe various components, but the components may not be limited by the terms. The terms are used only for the purpose of distinguishing one component from another. For example, a second component may be referred to as a first component, and similarly, the first component may also be referred to as the second component without departing from the scope of the present invention.

The term “and/or” includes a combination of a plurality of related listed items or any of the plurality of related listed items.

When a first component is described as being “connected” or “coupled” to a second component, it can be understood that the first component may be directly connected or coupled to the second component, but a third component may be present therebetween. On the other hand, when the first component is described as being “directly connected” or “directly coupled” to the second component, it can be understood that the third component is not present therebetween.

The terms used in the present application are only used to describe specific embodiments and are not intended to limit the present invention. A singular expression includes a plural expression unless the context clearly dictates otherwise.

In the present application, it can be understood that terms “include” or “have” are intended to specify that a feature, a number, a step, an operation, a component, a part, or a combination thereof described in the specification is present, but do not preclude the possibility of the presence or addition of one or more other features, numbers, steps, operations, components, parts, or combinations thereof.

Unless defined otherwise, all terms used herein, including technical or scientific terms, have the same meaning as commonly understood by those skilled in the art to which the present invention pertains.

The terms defined in a generally used dictionary can be construed as meanings that match with the meanings of the terms from the context of the related technology and are not construed as an ideal or excessively formal meaning unless clearly defined in the present application.

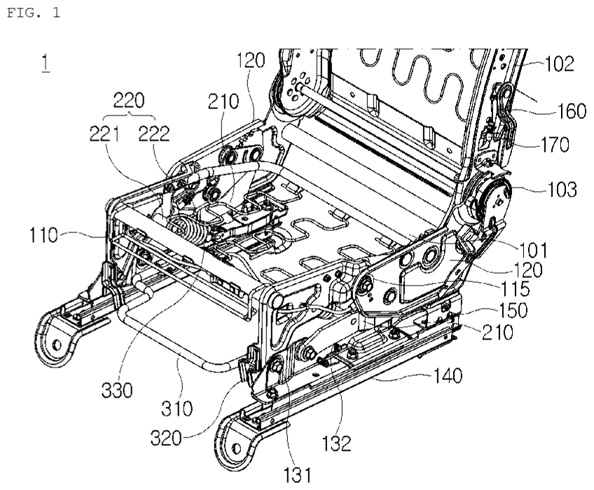

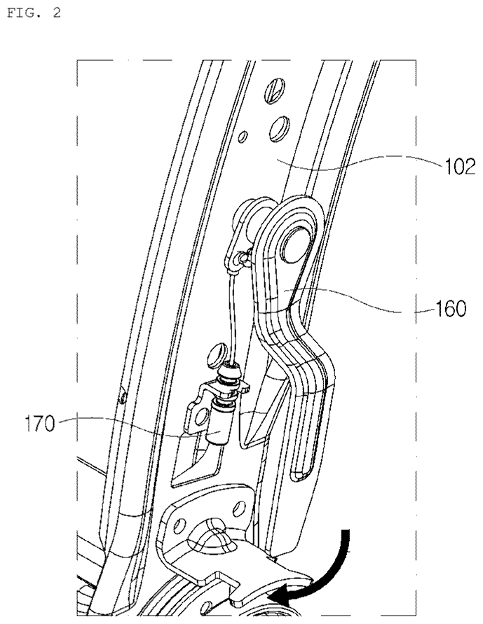

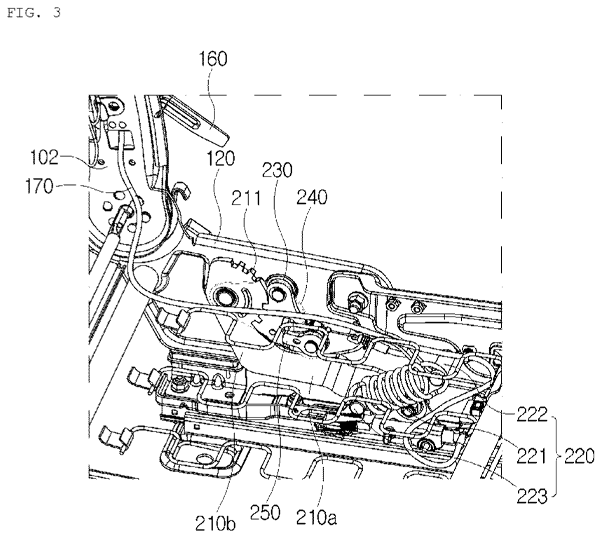

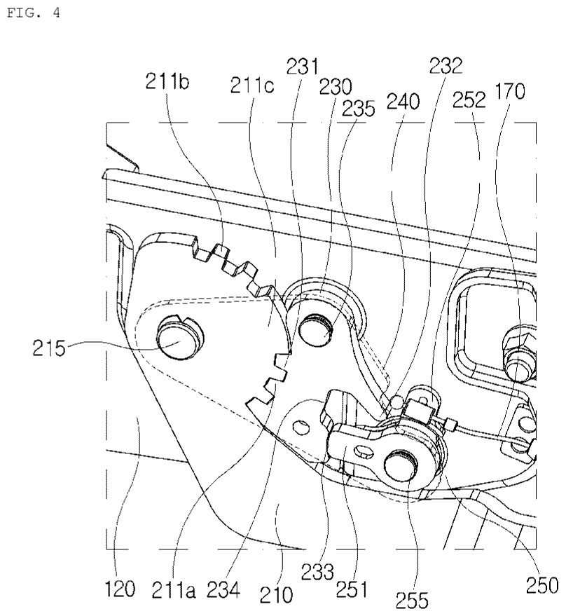

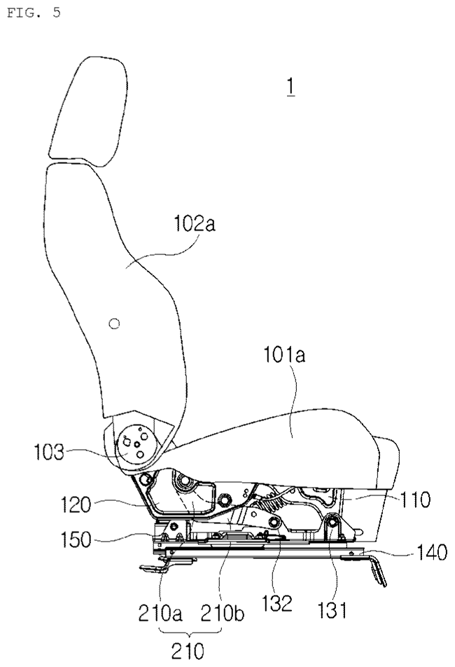

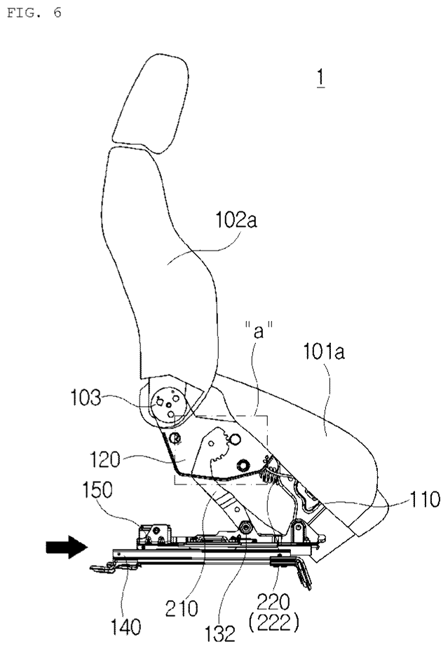

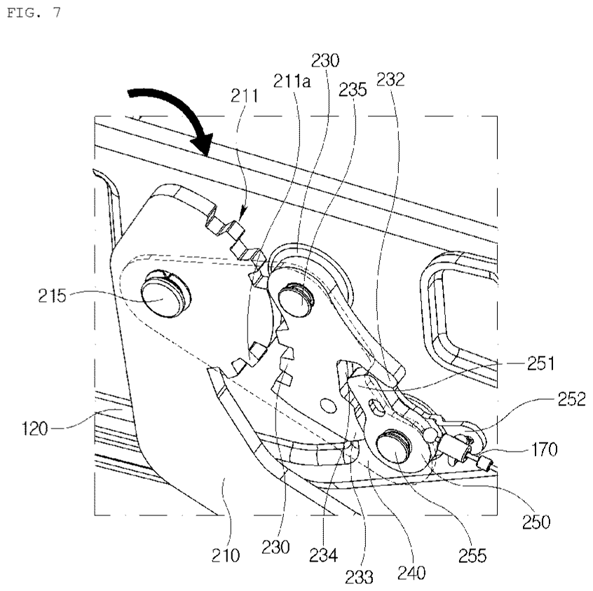

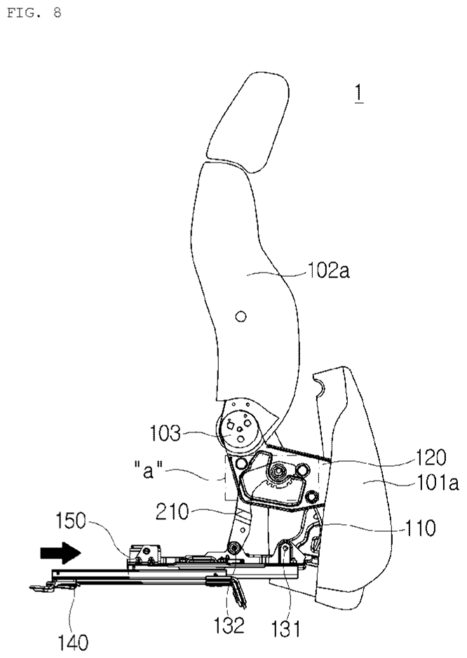

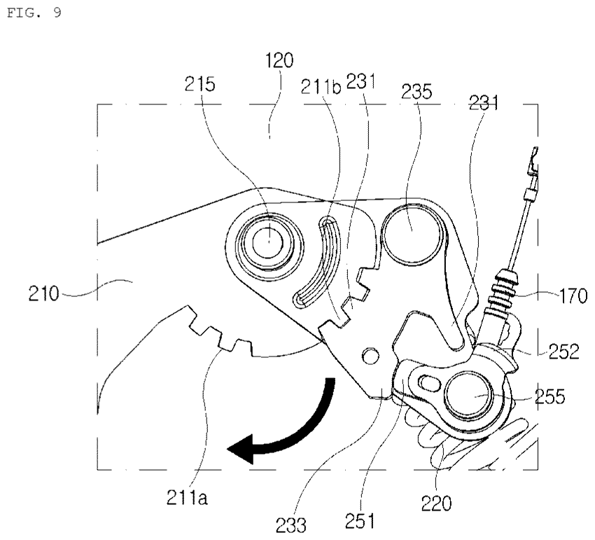

FIG. 1 is an exploded perspective view of main parts of a vehicle seat provided with a walk-in adjustment device according to one embodiment of the present invention, FIG. 2 is an enlarged view of a seatback frame area provided with a stand-up lever of FIG. 1, FIG. 3 is a perspective view of the walk-in adjustment device of FIG. 1 when viewed in an opposite direction, FIG. 4 is an enlarged view illustrating main parts of FIG. 3, FIG. 5 is a side view of a vehicle seat provided with the walk-in adjustment device according to one embodiment of the present invention before walk-in operation, FIG. 6 illustrates a state in which a walk-in mode of FIG. 5 is in progress, in which the seat partially moves forward, a seatback remains upright, and a seat cushion rotates and stands up, FIG. 7 is an enlarged view illustrating main parts of FIG. 6, FIG. 8 illustrates a completed state of the walk-in mode of FIG. 6, in which the seat has moved forward and the seatback and the seat cushion have been positioned in fully upright positions, and FIG. 9 is an enlarged view illustrating main parts of FIG. 8.

Referring to FIGS. 1 to 9, a vehicle seat 1 of the present embodiment may generally include a fixed rail 140, a movable rail 150, a rail lock 330, a seat cushion frame 101, a seatback frame 102, a recliner 103, a track lever 310, and a release bracket 320.

The fixed rail 140 may be installed in pairs on the floor of the vehicle. A pair of movable rails 150 are installed on the pair of fixed rails 140. The movable rails 150 may be movably installed on the fixed rails 140 and may support the seat cushion frame 101.

Accordingly, the fixed rails 140 and the movable rails 150 are installed so that a seat cushion 101a (see FIG. 5) and a seatback 102a (see FIG. 5) may move forward and backward, that is, in a straight line.

The rail lock 330 may fix the position of the movable rail 150 on the fixed rail 140 and may be installed to be exposed to the movable rail 150. This will be described below.

The seat cushion frame 101 may form a horizontal frame on which the seat cushion 101a (see FIG. 5) is installed and include various components.

For example, the seat cushion frame 101 may have a front plate 110 hinge-coupled to a front surface of the movable rail 150, and a rear plate 120 having one end hinge-coupled to the front plate 110.

Here, the front plate 110 and the rear plate 120 may be rotatably coupled by a hinge shaft 115. The front plate 110 and the rear plate 120 may be coupled to form a base plate of the seat cushion frame 101.

The seatback frame 102 may be rotatably installed on the seat cushion frame 101 and may form a vertical frame on which the seatback 102a (see FIG. 5) is installed.

The recliner 103 may be installed at a connection point between the seatback frame 102 and the seat cushion frame 101 to adjust an angle of the seatback frame 102. That is, the seatback frame 102 and the seat cushion frame 101 may be coupled to the recliner 103 via a recliner shaft to adjust the angle.

The track lever 310 may have one end portion rotatably coupled to the movable rail to selectively come into contact with the rail lock 330, and the release bracket 320 may come into contact with the track lever 310 so that the rail lock 300 is linked according to the rotation of the rear link 210 of the tilting-type walk-in adjustment device, which will be described below.

The track lever 310 and the release bracket 320 will be described below.

Meanwhile, the vehicle seat 1 of the embodiment is a tilting-type walk-in adjustment device and may include a rear link 210, a rocker arm 230, a release bracket 250, a stand-up lever 160, and a cable 170. Here, the rear link 210, the rocker arm 230, the release bracket 250, the stand-up lever 160, and the cable 170 may be referred to as an external locking module.

Referring to FIGS. 3 and 4, the rear link 210 may have a sector gear unit 211 rotatably installed on the rear plate 120 and the other end hinge-coupled to a rear surface of the movable rail 150 by a second hinge shaft 132.

The front surface of the movable rail 150 is hinge-coupled to the front plate 110 by a first hinge shaft 131. The front plate 110 may have a short range of movement via the first hinge shaft 131, and the rear plate 120 may have a large range of movement via the second hinge shaft 132 and the rear link 210.

That is, the front plate 110, the rear plate 120, the rear link 210, and the movable rail 150 of the seat cushion frame 101 form a four-bar linkage, enabling a tilting-type walk-in operation of the seat.

To this end, the rear link 210 may include a horizontal link 210a rotatably installed on the rear plate 120, and a vertical link 210b extending from the horizontal link 210a and having the sector gear unit 211 provided at an end portion thereof. That is, the rear link 210 may have an “L” shape.

Due to the shape of the rear link 210, as illustrated in FIG. 5, the rear link 210 may support the seat cushion 101a in a horizontal state, and as illustrated in FIG. 8, the rear link 210 may support the seat cushion 101a in a vertical state (stood-up state).

Referring to FIG. 4, the sector gear unit 211 of the rear link 210 may include a first sector gear 211a that engages with the rocker arm 230, a second sector gear 211b that engages with the rocker arm 230 during rotation of the rear link 210, and a connecting protrusion 211c that connects the first sector gear 211a to the second sector gear 211b.

The sector gear unit 211 may have a semi-arc shape and may be installed adjacent to the rocker arm 230 so as to be rotatable with respect to the rear plate 120 via a rotational shaft 215.

The rocker arm 230 may engage with the sector gear unit 211 of the rear link 210 and may be rotatably installed on the rear plate 120 via the rotational shaft 235.

More specifically, the rocker arm 230 may include a locking gear 231 that engages with the sector gear unit 211, a stopper 232 that limits the range of movement of the release bracket 250, a locking protrusion 233 that selectively comes into contact with the release bracket 250, and an unlocking groove 234 that is recessed between the stopper 232 and the locking protrusion 233.

The locking gear 231 may be positioned on one side (left side) of the rocker arm 230, and the stopper 232, the locking protrusion 233, and the unlocking groove 234 may be positioned on the other side (right side) of the rocker arm 230.

The release bracket 250 may selectively engage with the rocker arm 230 to lock and unlock the rocker arm 230 and may be rotatably mounted on the rear plate 120 via a rotational shaft 255.

In addition, the release bracket 250 may include a release protrusion 251 that selectively comes into contact with the locking protrusion 233 and the unlocking groove 234, and a cable connection portion 252 that is connected to the cable 170 and rotates the release bracket 250.

For example, the release protrusion 251 may have a protrusion shape that protrudes in one direction centered on the rotational shaft 255.

The cable connection portion 252 may be positioned to have an inclined angle with the release protrusion 251.

When the cable connection portion 252 is pulled by the cable 170, the release bracket 250 may rotate about the rotational shaft 255 to change the position of the release protrusion 251.

Accordingly, the release protrusion 251 may come into contact with the locking protrusion 233 of the rocker arm 230, as illustrated in FIGS. 4 and 9, and may be positioned between the locking release grooves 234 of the rocker arm 230, as illustrated in FIG. 7.

The walk-in adjustment device for a vehicle seat of the present invention may further include a cover bracket 240 coupled to the rotational shafts 215, 235, and 255 of the rear link 210, the rocker arm 230, and the release bracket 250. The cover bracket 240 may function to prevent detachment of and protect the components.

The stand-up lever 160 may be installed on the seatback frame 102. The stand-up lever 160 may be operated by a user to pull or push. The stand-up lever 160 may be linked with the cable 170 to enter or exit the tilting-type walk-in mode of the vehicle seat.

The cable 170 may connect the stand-up lever 160 to the release bracket 250 and transmit the operation of the stand-up lever 160 to the release bracket 250, thereby controlling the operation of the release bracket 250. That is, the release bracket 250 may lock and unlock the rocker arm 230.

Meanwhile, the walk-in adjustment device for a vehicle seat of the present invention may further include a return unit 220 having one side fixed to the movable rail 150 and the other side fixed to the rear plate 120.

The return unit 220 may provide a restoring force to assist the vehicle seat 1 in returning from the tilting walk-in mode to the normal mode.

Referring to FIG. 3, the return unit 220 may include a first fixing pin 222 installed on the rear plate 120, a second fixing pin 223 installed on the movable rail 150, and coil springs 221 installed on the first fixing pin 222 and the second fixing pin 223.

The operation of the walk-in adjustment device for a vehicle seat, which includes the above configuration and a vehicle seat having the same will be described with reference to the above-described drawings.

As illustrated in FIG. 5, when the stand-up lever 160 mounted on the seatback frame 102 is operated in a state in which the position of the seat 1 is normally fixed (locked), as illustrated in FIG. 2, the cable 170 may rotate the release bracket 250 to enter the tilting walk-in mode.

That is, as illustrated in FIG. 4, in the locked state of the seat, the release protrusion 251 of the release bracket 250 is maintained in a state of contact with the locking protrusion 233 of the rocker arm 230. In this case, the first sector gear 211a of the rear link 210 and the locking gear 231 of the rocker arm 230 are engaged.

When the stand-up lever 160 is operated for the tilting walk-in mode, as illustrated in FIG. 7, the cable 170 pulls the cable connection portion 252 of the release bracket 250 so that the release protrusion 251 of the release bracket 250 is inserted into the unlocking groove 234 of the rocker arm 230, thereby releasing the locking.

Accordingly, when the user pushes the seatback 102a forward (to the right side in the drawing), as illustrated in FIG. 6, the movable rail 150 and the seatback 102a may move, and the seat cushion 101a may be gradually lifted, and then completely erected in a vertical position, as illustrated in FIG. 9.

Here, depending on the shape and structure of the rear link 210, the rear plate 120 rotates about the rotational shaft 115 and is folded with respect to the front plate 110 (see FIGS. 6 and 8).

As illustrated in FIG. 8, in a state in which the tilting walk-in of the seatback 102a and the seat cushion 101a is completed, the rear link 210 supports and locks the seatback 102a and the seat cushion 101a.

More specifically, the second sector gear 211b of the rear link 210 and the locking gear 231 of the rocker arm 230 are engaged, and the release protrusion 251 of the release bracket 250 may come into contact with the locking protrusion 233 of the rocker arm 230 to maintain the locking.

Meanwhile, the walk-in adjustment device for a vehicle seat and the vehicle seat 1 having the same according to the above embodiment may have the inconvenience of having to directly move the track lever 310 to unlock the movable rail 150 and then push the seat when implementing the tilting walk-in mode.

To this end, the vehicle seat 1 according to the embodiment is a tilting type walk-in adjustment device, which allows the stand-up operation and the rail release to be implemented simultaneously, thereby providing a structure in which the movable rail 150 may be unlocked and the seat may be moved forward without directly moving the track lever 310.

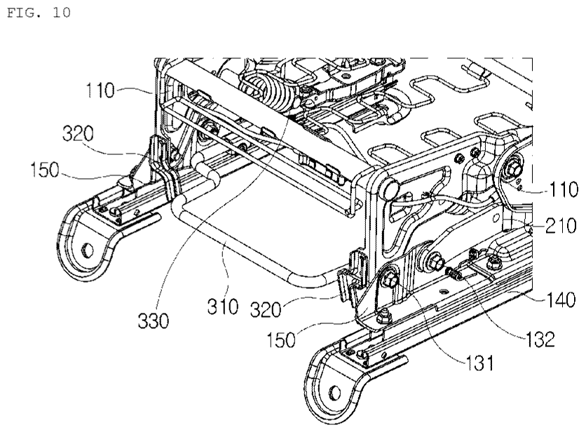

FIG. 10 is an enlarged view illustrating main parts of FIG. 1.

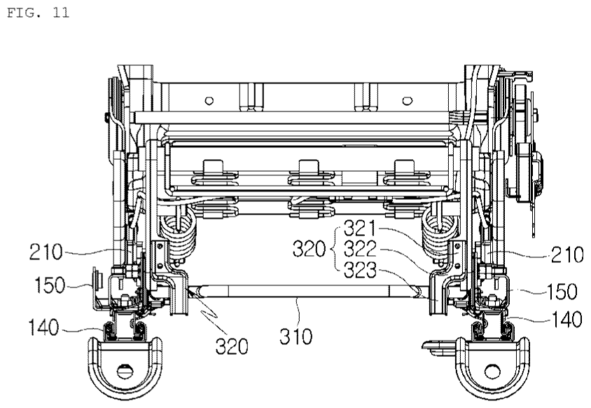

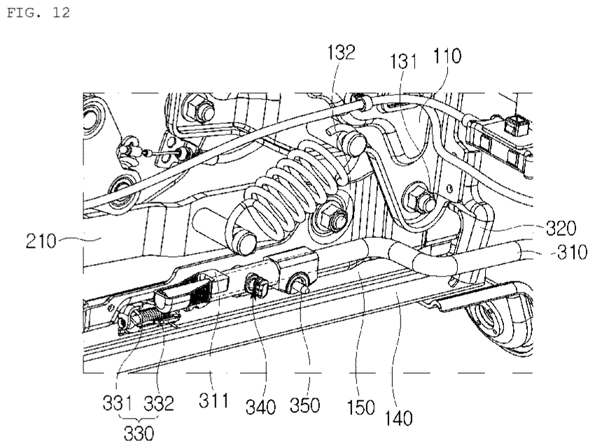

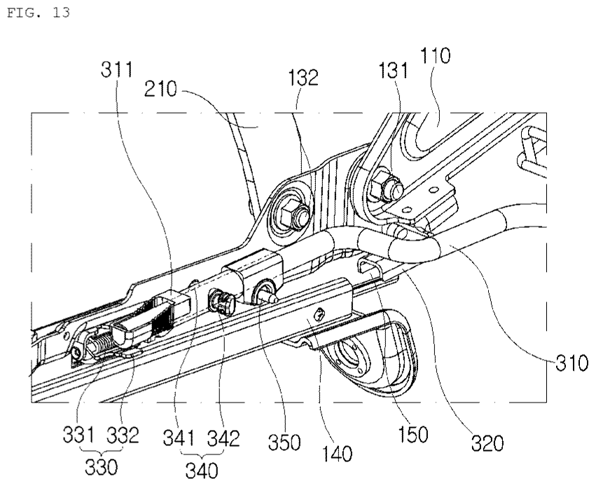

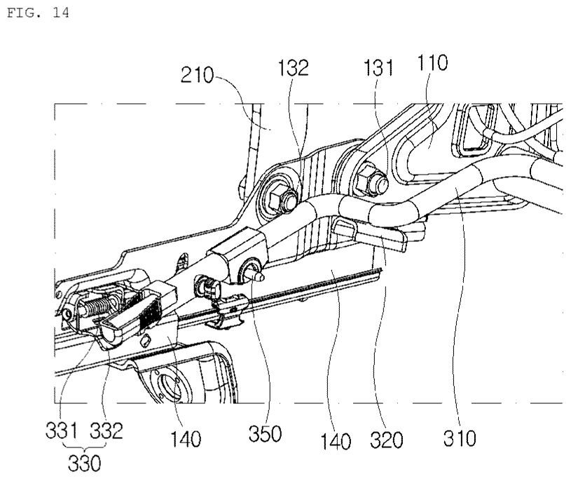

FIG. 11 is a front view of FIG. 10, FIG. 12 illustrates a state before the seat stands up, in which a release bracket does not come into contact with a track lever, FIG. 13 illustrates the seat during the stand-up operation, in which the release bracket comes into contact with the track lever and an end cover presses a rail lock, and FIG. 14 illustrates a state after the seat stands up, in which the release bracket comes into contact with the track lever and the end cover maximally presses a rail lock.

Referring to FIGS. 10 to 14, the walk-in adjustment device for a vehicle seat and the vehicle seat 1 having the same according to the embodiment include the track lever 310 rotatably coupled to the movable rail so that one end portion thereof selectively comes into contact with the rail lock 330, and the release bracket 320 that is coupled to the front plate 110 so that the rail lock 330 is linked according to the rotation of the rear link 210 and comes into contact with the track lever 310.

The rail lock 330 may include the lock bracket 332 that selectively comes into contact with an end cover 311 of the track lever 310 to lock and unlock the movable rail 150 and the fixed rail 140, and a lock spring 331 that elastically supports the lock bracket 332.

The track lever 310 may be formed of pipe and formed in a bent form so that both end portions are rotatably coupled to the movable rail 150.

The track lever 310 protrudes from a lower front area of the seat cushion frame 100 so that a front surface functions as a handle that a user may grasp to lift or lower. Connection points between the front surface and both end portions of the track lever 310 may have a bend section that is again bent inward to avoid interference with the movable rail 150.

In addition, the track lever 310 may include the end cover 311, a lever rotational shaft 350, and a lever stopper 340, as illustrated in FIGS. 12 to 14, to come into contact with the rail lock 330.

The end cover 311 may surround the end portion of the track lever 310 and come into contact with the rail lock 330. For example, the end cover 311 may have a pipe shape that surrounds an end area of the track lever 310.

The lever rotation 350 may rotatably couple the end cover 311 to the movable rail 150. For example, the lever rotational shaft 350 may be positioned adjacent to the end cover 311 and the track lever 310. Accordingly, the end cover 311 may move in a direction opposite to the track lever 310 with respect to the lever rotational shaft 350.

The lever stopper 340 may limit the range of rotation of the end cover 311. That is, the lever stopper 340 may limit the range of movement of the end cover 311 so that the end cover 311 comes into contact with the rail lock 330 or is spaced a predetermined distance from the rail lock 330.

For example, the lever stopper 340 may include a long hole 341 formed through the movable rail 150 and a long hole shaft 343 coupled to the end cover 311 and inserted into the long hole 341.

The release bracket 320 may unlock the movable rail 150 while coming into contact with the track lever 310 as the front plate 110 rotates vertically. To this end, the release bracket 320 may be provided in pairs, with each release bracket installed on the front plate 110.

In this case, the pair of release brackets 320 may be installed to be positioned in the bent section of the track lever 310, as illustrated in FIGS. 10 and 11.

The release bracket 320 may have various shapes.

For example, the release bracket 320 may include a fixed piece 321 fixed to the front plate 100, an extension piece 322 extending from the fixed piece 321, and a support piece 323 that is connected to the extension piece 322 and supports the track lever 310.

Here, the fixed piece 321 may be fixed to the front plate 110 by welding. Of course, the fixed piece 321 may also be fixed using a fastener, such as a bolt or nut, instead of welding.

With the above configuration, the vehicle seat 1 according to the embodiment is a tilting type walk-in adjustment device, which allows the stand-up operation and the rail release to be implemented simultaneously, thereby providing a structure in which the movable rail 150 may be unlocked and the seat may be moved forward without directly moving the track lever 310, as illustrated in FIGS. 6 and 8.

In this way, according to the walk-in adjustment device for a vehicle seat and a vehicle seat including the same of the present invention, locking/unlocking can be achieved through the external locking module while reducing the number of components, such as conventional latches, strikers, etc., and the tilting walk-in operation can be implemented quickly and precisely with the simple mechanism.

In addition, the present invention can provide the structure applicable to both first-and second-row seats in a vehicle, thereby maximizing the walk-in-through space and the luggage space.

According to the walk-in adjustment device for a vehicle seat and a vehicle seat including the same of the present invention, locking/unlocking can be achieved via the external locking module while reducing the number of components, such as conventional latches, strikers, etc., and the tilting walk-in operation can be implemented quickly and precisely with the simple mechanism.

The present invention can provide a structure in which the stand-up operation and rail release are simultaneously implemented, thereby unlocking the moving rail and allowing the seat to move forward without directly moving the track lever.

In addition, the present invention can provide the structure applicable to both first-and second-row seats in a vehicle, thereby maximizing the walk-in-through space and the luggage space.

Although the present invention has been described in detail through specific embodiments, this is intended to specifically describe the present invention, and it is apparent that the present invention is not limited thereto, and the present invention can be modified or improved by those skilled in the art without departing from the technical spirit of the present invention.

All simple modifications or changes of the present invention fall within the scope of the present invention, and the specific scope of the present invention will be made clear by the appended claims.

### DESCRIPTION OF REFERENCE NUMERALS

| | |
|---|---|
| 1: vehicle seat | 101: seat cushion (frame) |
| 102: seatback (frame) | 110: front plate |
| 115: hinge shaft | 120: rear plate |
| 131: first hinge shaft | 132: second hinge shaft |
| 140: fixed rail | 150: movable rail |
| 160: stand-up lever | 170: cable |
| 210: rear link | 210a: horizontal link |
| 210B: vertical link | 211: sector gear unit |
| 211a: first sector gear | 211b: second sector gear |
| 211c: connecting protrusion | 215: rotational shaft |
| 220: return unit | 221: coil spring |
| 222, 223: fixed pin | 230: rocker arm |
| 231: locking gear | 232: stopper |
| 233: locking protrusion | 234: unlocking groove |
| 235: rotational shaft | 240: cover bracket |
| 250: release bracket | 251: release protrusion |
| 255: rotational shaft | 310: track lever |
| 311: end cover | 320: release bracket |
| 321: fixed piece | 322: extension piece |
| 323: support piece | 330: rail lock |
| 331: lock spring | 332: lock bracket |
| 340: lever stopper | 341: long hole |
| 342: long hole shaft | 350: lever rotational shaft |

What is claimed is:

1. A walk-in adjustment device for a vehicle seat, comprising:
a movable rail movably installed on a fixed rail;
a front plate hinge-coupled to a front surface of the movable rail;
a rear plate hinge-coupled to the front plate;
a rear link whose one side is rotatably installed on the rear plate and the other side hinge-coupled to a rear surface of the movable rail;
a rail lock which selectively fixes the position of the movable rail and is installed to be exposed to the movable rail;
a track lever rotatably coupled to the movable rail so that one end portion selectively comes into contact with the rail lock; and
a release bracket which is coupled to the front plate so that the rail lock is linked according to the rotation of the rear link and comes into contact with the track lever.

2. The walk-in adjustment device of claim 1, wherein the release bracket releases the fixation of the movable rail by coming into contact with the track lever as the front plate rotates vertically.

3. The walk-in adjustment device of claim 1, wherein the release bracket includes:
a fixed piece fixed to the front plate;
an extension piece extending from the fixed piece; and
a support piece which is connected to the extension piece and supports the track lever.

4. The walk-in adjustment device of claim 3, wherein the fixed piece is fixed to the front plate by welding.

5. The walk-in adjustment device of claim 3, wherein the track lever includes:
an end cover which surrounds an end portion of the track lever and comes into contact with the rail lock;
a lever rotational shaft which rotatably couples the end cover to the movable rail; and
a lever stopper which limits a range of the rotation of the end cover.

6. The walk-in adjustment device of claim 5, wherein the lever stopper includes:
a long hole formed through the movable rail; and
a long shaft coupled to the end cover and inserted into the long hole.

7. The walk-in adjustment device of claim 5, wherein the rail lock includes:
a lock bracket which selectively comes into contact with the end cover to lock and unlock the movable rail and the fixed rail; and
a lock spring which elastically supports the lock bracket.

8. The walk-in adjustment device of claim 1, wherein the rear link includes:
a sector gear unit rotatably installed on the rear plate;
a horizontal link rotatably installed on the rear plate; and
a vertical link extending from the horizontal link and having the sector gear unit provided at an end portion thereof.

9. The walk-in adjustment device of claim 1, wherein the rear link includes a sector gear unit rotatably installed on the rear plate, and
further comprising a rocker arm rotatably installed on the rear plate so that one end engages with the sector gear unit of the rear link and the other end selectively engages with the release bracket.
